(19) United States
(12) Patent Application Publication
(10) Pub. No.: US 2021/0306304 A1
(43) Pub. Date: Sep. 30, 2021

(54) METHOD AND APPARATUS FOR DISTRIBUTING CONFIDENTIAL EXECUTION SOFTWARE

(71) Applicant: ELECTRONICS AND TELECOMMUNICATIONS RESEARCH INSTITUTE, Daejeon (KR)

(72) Inventors: Woomin HWANG, Daejeon (KR); Chulwoo LEE, Daejeon (KR); Sung-Jin KIM, Daejeon (KR); Hyunyi YI, Daejeon (KR); Byungjoon KIM, Daejeon (KR)

(21) Appl. No.: 16/933,427

(22) Filed: Jul. 20, 2020

(30) Foreign Application Priority Data
Mar. 26, 2020 (KR) 10-2020-0036903

(51) Int. Cl. H04L 29/06; G06N 20/00; G06N 5/04

(52) U.S. Cl. CPC H04L 63/0428; G06N 5/04; G06N 20/00; H04L 63/1433

(57) ABSTRACT

A method and apparatus for distributing confidential execution software. The method includes loading a payload into memory in a confidential execution region, checking a vulnerability related to the payload, generating bridge code for calling a function that is not present in the payload, among functions used in the payload, generating confidential execution code for generating a confidential execution region in a target cloud node having privileges to execute the payload, encrypting the payload, and distributing the confidential execution code and the encrypted payload.

### CROSS REFERENCE TO RELATED APPLICATION

This application claims the benefit of Korean Patent Application No. 10-2020-0036903, filed Mar. 26, 2020, which is hereby incorporated by reference in its entirety into this application.

### BACKGROUND OF THE INVENTION

### 1. Technical Field

The present invention relates generally to technology for encrypting applications or shared libraries, and more particularly to technology for protecting execution of a program using the encryption function of some memory regions provided by hardware while encrypting an executable file or a shared library without changing an executable binary in a bare-metal system or a cloud-computing environment.

### 2. Description of Related Art

General applications running at a user level operate based on trust in an operating system (OS) and a hypervisor, which provide an execution platform in native and cloud environments, respectively. Therefore, a host may check all the information of the applications with administrator's access permissions or the like from the viewpoint of the system.

However, such general applications have a problem in which they are vulnerable to data-stealing attacks based on memory access from the outside, for example, by discovering vulnerabilities in the binary code of a target application through static reverse-engineering analysis or by extracting encryption/decryption keys by accessing and analyzing the memory used by the target application after acquiring permission to access an OS or a hypervisor. Particularly, with the advancement and popularization of cloud platforms, vulnerabilities that can cause data leakage or an escape from an isolation region, which use multi-tenant characteristics of a cloud, are frequently discovered, and the number of data leakage cases using platform administration privileges appropriated by exploiting such vulnerabilities is increased, whereby the above-mentioned problems are aggravated.

In order to solve these problems, many CPU manufacturers have proposed a method for performing a desired operation without exposing content stored in the specified memory of a user even if a malicious program running at the same user level sneaks a look at memory or even if high privileges are appropriated by a malicious user or administrator in an OS, a hypervisor, or the like.

Intel released Software Guard Extension (SGX) technology, which is configured to protect memory information by trusting only a CPU and by imposing the use of specific code stored in an isolated protection region when a specified memory region is accessed, and AMD released Secure Encrypted Virtualization (SEV) technology, which is configured to protect data by isolating the memory of each virtual machine by encrypting memory regions that are used for respective virtual machines. ARM released TrustZone technology, having a purpose similar to the purpose of the above technologies.

As research related to the above technologies, two papers were published in 2017. The first paper, titled “SGXIO: Generic Trusted I/O Path for Intel SGX” and published in CODASPY in 2017, proposed a method enabling user software protected by Software Guard Extension (SGX) to be securely run on a compromised OS in such a way that a lightweight hypervisor protects a data path for using I/O devices. This is technology for protecting the I/O data of an application developed using SGX, which is input/output outside an enclave, but has a disadvantage in that confidential execution of a general application is not possible. Also, when the functions of a CPU are allowed at a guest user level in a cloud environment, there is a limitation in that it is necessary to additionally provide a nested function for running a lightweight hypervisor on a virtual machine or in a container instance.

The second paper, titled “SGXCrypter: IP protection for portable executables using Intel's SGX technology” and published in IEEE 22th Asia and South Pacific Design Automatic Conference (ASP-DAC) 2017, proposed a program structure for executing a Portable Executable (PE) format inside Software Guard Extension (SGX) using Intel's SGX functions, thereby implementing a method for executing a non-SGX executable program in an enclave. However, the format of the payload is limited to a statically compiled executable program. Also, this paper does not present solutions for issues, such as a countermeasure for a PE using a shared library, an execution method when a payload is a shared library, distribution and execution control, and the like.

### DOCUMENTS OF RELATED ART

(Non-Patent Document 1) Samuel Weiser, Mario Werner “SGXIO: Generic Trusted I/O Path for Intel SGX”, published on Jan. 4, 2017
(Non-Patent Document 2) D. Tychalas et al. “SGXCrypter: IP protection for portable executables using Intel's SGX technology”, published on Jan. 16, 2017.

### SUMMARY OF THE INVENTION

An object of the present invention is to protect executable code stored in volatile and nonvolatile storage used by a virtual machine or a container instance running in a cloud environment, to release a secure program, and to protect data loaded into specified memory during execution while performing version management and execution control.

Another object of the present invention is to, when a publisher generates one or more payloads by encrypting a binary compiled into the form of an executable file or a library and distributes the payloads along with confidential execution code for configuring the environment required for execution of the payloads, enable a user to execute the payload in a secure execution environment generated by the confidential execution code.

A further object of the present invention is to reduce leakage of executable code and protect critical information even if user's privileges for management of a virtual machine or a container are appropriated by an attacker or a malicious cloud provider or even if memory dump data is leaked through a memory dump of data stored in permanent storage, a snapshot of the virtual machine, or the like.

In order to accomplish the above objects, a method for distributing confidential execution software according to an embodiment of the present invention may include loading each of one or more payloads into memory; checking a vulnerability related to the payload; generating bridge code for replacing a function that is not present in the payload, among functions used in the payload, with a function call outside of the payload; generating confidential execution code for generating a confidential execution region in a target cloud node having privileges to execute the payload; encrypting the payload; and distributing the confidential execution code and the encrypted payload.

Here, generating the bridge code may be configured to extract a list comprising a function required in order for code in the payload to execute code that is present outside the confidential execution region and a function to be called when an external process invokes code included in the payload, and be configured to generate the bridge code based on the list.

Here, the confidential execution code may include at least one component that is necessary in order to implement a Confidential Execution Engine (CEE).

Here, the component may include at least one of an in-enclave loader, a decryptor, a Key Management System (KMS) client, an additional security function module, a sleep-mode handler, an execution control module, and an in-enclave library.

Here, encrypting the payload may be configured to receive an encryption key from an external server and to encrypt the payload based thereon.

Here, the encryption key may be generated by the external server based on at least one of identification information of a corresponding Confidential Execution Engine (CEE) and version information of the payload.

Here, checking the vulnerability may be configured to additionally check whether a security measure is applied to the payload through static binary analysis on the payload.

Here, checking the vulnerability may be configured to immediately stop a running process when the vulnerability related to the payload is found.

Here, the payload may be an executable file or a shared library.

Also, a method for executing confidential execution software according to an embodiment of the present invention may include initializing a confidential execution region; checking a condition for confidential execution; loading an encrypted payload into memory in the confidential execution region; receiving a decryption key from an external server; decrypting the payload using the decryption key; redeploying the decrypted payload in the confidential execution region; writing a list of the positions of target substitute functions and connecting a function in the payload with the target substitute function; and executing code in the payload.

Here, the confidential execution region may include at least one of an in-enclave loader, a decryptor, a Key Management System (KMS) client, an additional security function module, a sleep-mode handler, an execution control module, and an in-enclave library.

Here, checking the condition for the confidential execution may be configured to check whether an environment in which the confidential execution software is executed satisfies a preset execution environment condition and to immediately terminate execution of the confidential execution software when the preset execution environment condition is not satisfied.

Also, an apparatus for distributing confidential execution software according to an embodiment of the present invention may include a payload-loading unit for loading a payload for generating confidential execution code into memory; a vulnerability-checking unit for checking a vulnerability related to the payload; an encryption key reception unit for receiving an encryption key from an external server; an encryption unit for encrypting the payload using the encryption key; a confidential execution code generation unit for generating confidential execution code for the payload; and a distribution unit for distributing the encrypted payload and the confidential execution code.

Here, the confidential execution code may include at least one component that is necessary in order to implement a Confidential Execution Engine (CEE).

Here, the component may include at least one of an in-enclave loader, a decryptor, a Key Management System (KMS) client, an additional security function module, a sleep-mode handler, an execution control module, and an in-enclave library.

Here, the encryption key may be generated by the external server based on at least one of identification information of a corresponding Confidential Execution Engine (CEE) and version information of the payload.

Here, the vulnerability-checking unit may additionally check whether a security measure is applied to the payload through static binary analysis on the payload.

Here, the vulnerability-checking unit may immediately stop a running process when the vulnerability related to the payload is found.

Here, the payload may be an executable file or a shared library.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a block diagram illustrating an example of a system in which the present invention is applied;

FIG. 2 illustrates an example of the operation of an apparatus for distributing confidential execution software according to an embodiment of the present invention;

FIG. 3 illustrates an example of the operation of an apparatus for distributing confidential execution software according to another embodiment of the present invention;

FIG. 4 illustrates an example of components generated by an enclave generator according to an embodiment of the present invention;

FIG. 5 illustrates an example of an apparatus for executing confidential execution software according to an embodiment of the present invention;

FIG. 6 illustrates an example of an apparatus for executing confidential execution software according to another embodiment of the present invention;

FIG. 7 is a flowchart illustrating an example of a method for distributing confidential execution software according to an embodiment of the present invention;

FIG. 8 is a flowchart illustrating a part of the process of a method for distributing confidential execution software according to an embodiment of the present invention;

FIG. 9 is a flowchart illustrating another part of the process of a method for distributing confidential execution software according to an embodiment of the present invention;

FIG. 10 is a flowchart illustrating a part of the process of a method for distributing confidential execution software according to another embodiment of the present invention;

FIG. 11 is a flowchart illustrating another part of the process of a method for distributing confidential execution software according to another embodiment of the present invention;

FIG. 12 is a flowchart illustrating an example of a method for executing confidential execution software according to an embodiment of the present invention; and

FIG. 13 is a block diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

The environment in which the present invention is applied may be assumed to be a virtualized environment in which multiple virtual machines are accommodated and run together on a single cloud node or in which multiple containers run together. Here, a CPU installed in a cloud hardware node and used for running an application is required to be able to encrypt/decrypt data that a memory controller or a CPU module equivalent thereto records in a memory bus and a system memory region connected with the CPU through the memory bus.

The present invention is described as being targeted at a cloud node, in which a hypervisor capable of using Intel's SGX function is running, but may also be applied in various other environments, such as a container environment providing the same function, such as a docker or the like, a bare-metal environment, and the like. In the present specification, all of hypervisors and container engines that support the corresponding function are defined as ‘hosts’.

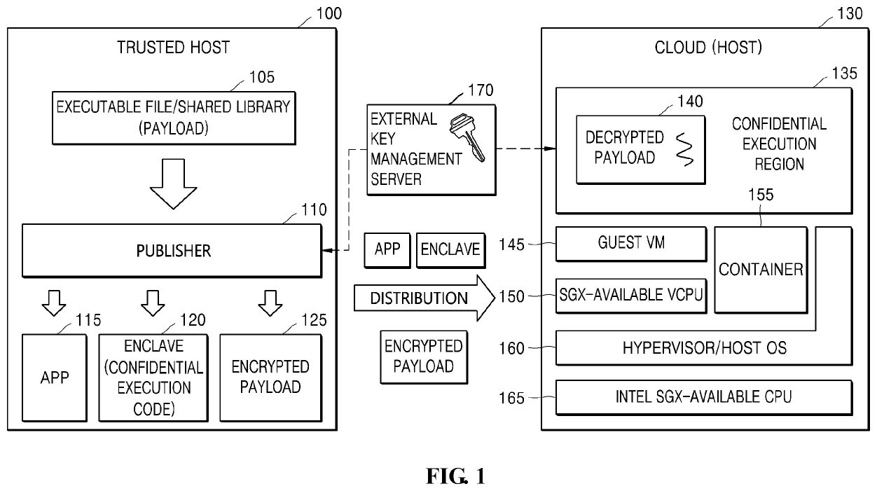

FIG. 1 is a block diagram illustrating an example of a system in which the present invention is applied.

Referring to FIG. 1, the system in which the configuration of the present invention is applied may include a trusted host 100 and a cloud node 130, and the components of an apparatus for distributing confidential execution software, which are to be described below, may be included in a publisher 110. The publisher 110 may generate an application 115, confidential execution code 120, and an encrypted payload 125 based on a payload 105 configured as an executable file or a shared library. Here, the publisher 110 may encrypt the payload using an encryption key received from an external key management server 170. Here, the payload 105 used by the publisher and the generated encrypted payload 125 may comprise one or more payloads. The cloud node 130 includes a confidential execution region 135, a guest virtual machine 145, an SGX-available vCPU 150, a container 155, a hypervisor/host OS 160, and an Intel-SGX-available CPU 165. The cloud node 130 decrypts the payload in the confidential execution region 135, thereby generating a decrypted payload 140.

As shown in FIG. 1, the trusted host 100 may distribute the application 115, the confidential execution code 120, and the encrypted payload 125, which are generated by the publisher 110 based on the payload 105, to the cloud node 130, and the cloud node 130 may generate the decrypted payload 140 by decrypting the payload in the confidential execution region 135.

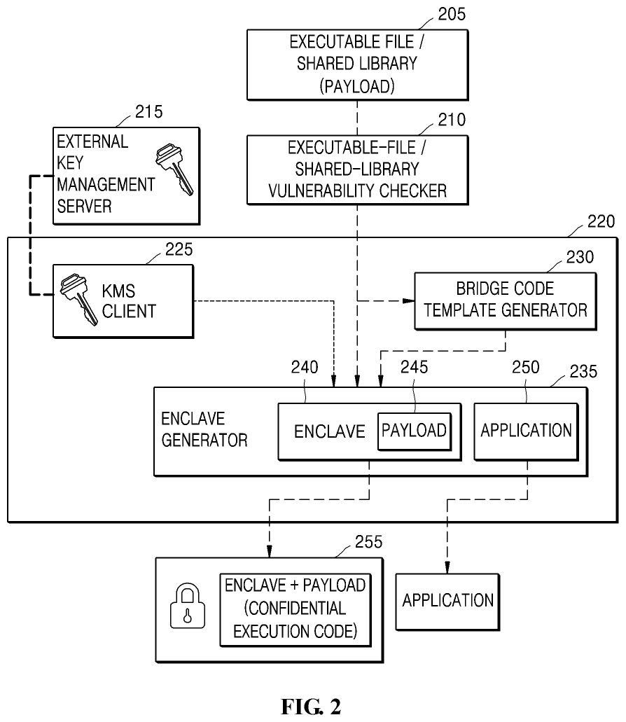

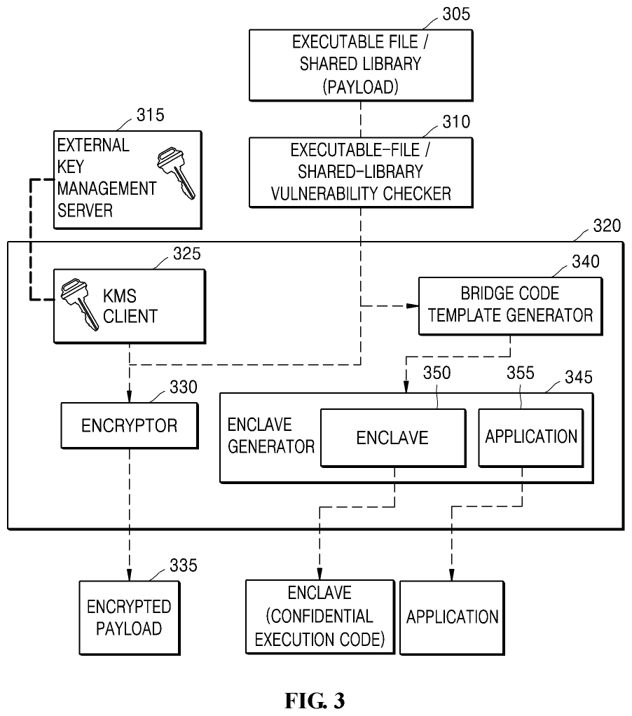

FIG. 2 and FIG. 3 illustrate an example of operation of an apparatus for distributing confidential execution software according to an embodiment of the present invention. FIG. 2 illustrates an example in which a payload is distributed along with confidential execution code by being combined therewith, and FIG. 3 illustrates an example in which a payload and confidential execution code are distributed separately.

Referring to FIG. 2, a publisher 220 is assumed to run based on a trusted host, and the publisher 220 includes a KMS client 225, a bridge code template generator 230, and an enclave generator 235. In FIG. 2, an executable-file/shared-library vulnerability checker 210 is illustrated as being separate from the publisher 220, but the executable-file/shared-library vulnerability checker 210 may be included in the publisher 220.

The bridge code template generator 230 generates bridge code that is to be used when the code of a payload responds to invocation from the outside of confidential execution code or when the code of the payload executes code outside the confidential execution region and brings the result. Specifically, when it is necessary for the code of the payload to call a function outside the confidential execution region or when an external process invokes the code in the payload, the bridge code template generator 230 extracts a list of the functions to be called. Then, the bridge code template generator 230 determines whether to generate an ecall (enclave call) function or an ocall (outside call) function depending on the type of the payload, and generates enclave internal adapter function code, an EDL function description file for defining a function interface at the boundary between trusted and untrusted regions, enclave external adapter function code, and constructor code. The generated chunks of code are combined by being compiled together along with the existing code in a second compile phase, or the chunks of code are compiled into individual files and are then combined with an existing binary in a linking phase.

The enclave internal adapter function code is a fixed connection point with a payload, and when the payload is an executable file and calls an external function, it becomes the position to which the context of the payload is moved and from which the external function is called. Here, the corresponding adapter function code invokes an ocall after it performs a task, such as preparing a required number of arguments, and the like, thereby serving as an adapter for executing external code through the interface specified by the bridge code template generator 230 and for importing and returning the execution result. When the payload is a shared library, the enclave internal adapter function code becomes an ecall invoked by process code outside the enclave. The ecall invokes the function connected therewith in the payload, which is intended to be invoked by the external process code, and exports and returns the result.

When the payload is an executable file, the enclave external adapter function code becomes an ocall invoked from the payload. The enclave external adaptor function calls the function that the payload attempted to invoke when the payload was executed outside the enclave, and returns the result to the inside of the enclave. Here, external code, such as other shared libraries and the like, is used if necessary. When the payload is a shared library, the corresponding adaptor function code serves as an adapter capable of performing processes related to invocation of an ecall, such as changing the name of the ecall such that the name of the function that the process code attempts to call can be used without change, receiving a result using an argument and returning the result, and the like, whereby the ecall becomes the function that is actually invoked when the code outside the enclave calls the corresponding function without changing the code. Also, when the payload is a shared library or when an external process intends to separate a task for initializing a confidential execution engine (CEE) from its original code, a constructor function for invoking ecalls related to a CEE preparation phase may be generated in order to enable tasks related to generation of an enclave to be automatically performed when the external process code loads the confidential execution engine code (the enclave.so code file). The constructor function may be compiled along with the external process code, or may be generated as a separate shared library such that the external process code uses the constructor function through the linkage to the same.

The Enclave Definition Language (EDL) function description file specifies the function prototypes of ecalls and ocalls, which are generated depending on the type of a payload, and specifies, if necessary, additional information defined by Intel, such as the types of the function parameters, a direction, indicating whether a value passes into or out of the call, other attributes of the parameters, and the like, thereby enabling Intel's enclave generation tool to perform required tasks for ecall and ocall that cross the boundary between trusted and untrusted regions when an enclave is generated.

In the case of internal/external functions generated by the bridge code template generator 230, a prefix that is set depending on a call direction is added to the names thereof, and the parameters thereof are configured such that a variable for receiving a return value is included as the first parameter thereof and the parameters included in the parameter list extracted from the original prototype of the function intended to be called by a caller are used without change as the following parameters thereof.

In order to automatically write ecalls and ocalls to the EDL function description file, the bridge code template generator 230 receives the path of a file system directory, from which the function prototypes thereof are to be retrieved, and retrieves the function prototype having the same name as the ecall or ocall, thereby extracting the parameter list thereof. Accordingly, the parameters of the function having the same name are adopted without change, but when the function prototype is not present or not found, a function having a void return type and no parameters is generated and is commented out such that the function is exposed to the user who runs the publisher.

The enclave generator 235 generates confidential execution engine code (enclave.so binary code), which generates a confidential execution region in a target cloud node. The corresponding code is generated by creating confidential execution engine code (enclave.so binary code) including necessary components and combining the same with code for implementing a confidential execution engine (CEE).

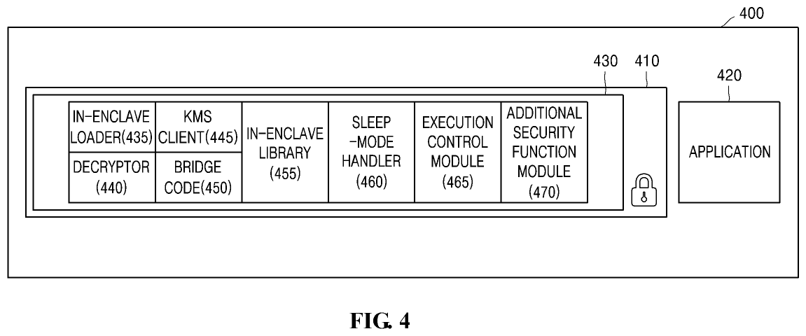

FIG. 4 illustrates an example of components generated by the enclave generator 235. Referring to FIG. 4, confidential execution code 410 may include a component set 430. The component set 430 may include at least one of an in-enclave loader 435, a decryptor 440, a KMS client 445, bridge code 450, an in-enclave library 445, a sleep-mode handler 460, an execution control module 465, and an additional security function module 470.

Referring again to FIG. 2, when code for generating the corresponding enclave is executed by the enclave generator 235, if execution is performed in an environment in which privileges for the memory allocated in the generated protected region cannot be changed, unsigned confidential execution code (an enclave.so shared library file) is generated by combining all chunks of component code, execution privileges are assigned to an allocated memory region in which a payload is to be located, and the confidential execution code (the enclave.so shared library file) is signed, whereby execution of the payload is enabled. If necessary, the enclave generator 235 may encrypt the code using the Protected Code Loader (PCL) function of Intel's SGX technology in order to protect the confidential execution code (enclave.so).

Before the publisher encrypts the payload, the executable-file/shared-library vulnerability checker 210 checks whether a known vulnerability is present in the payload, or checks through static binary analysis whether a desired security measure is applied. That is, whether a known vulnerability is present in the payload or whether a security measure required to be applied is applied is checked. When a known vulnerability is present in the payload or when a security measure required to be applied has not been applied, a specified follow-up task, such as stopping the process, notifying a user of the information, or the like, may be performed.

The KMS client 225 is executed in the protected region, and receives a key for encrypting the payload by communicating with an external key management server 215 using a secure key exchange protocol or receives a decryption key, which is based on identification information of the corresponding CEE, the version information of the payload, or the like.

The payload input to the publisher 220 may be an executable file or a file in the form of a shared library, and the program file distributed by the publisher 220 to the target machines may be configured using a static method in which the confidential execution engine code and the payload are distributed together, as shown in FIG. 2, or a dynamic method, in which the encrypted payload and the confidential execution engine code are distributed individually, as shown in FIG. 3, depending on the intention of the publisher. In the static method, in which the code related to confidential execution and the payload are generated as confidential execution engine code (an enclave.so shared library file) and distributed as shown in FIG. 2, the enclave generator 235 may protect the enclave code and the payload by receiving a key from the KMS client 225 and using Intel's Protected Code Loader (PCL) technology.

FIG. 3 illustrates an example of operation of an apparatus for distributing confidential execution software according to another embodiment of the present invention. The component having the same name as the component illustrated in FIG. 2, among the components illustrated in FIG. 3, may perform the same function as the component in FIG. 2. Therefore, in the present embodiment, a description will be made with a focus on differences from the embodiment of FIG. 2.

Referring to FIG. 3, the publisher 320 is assumed to operate based on a trusted host, and includes a KMS client 325, an encryptor 330, a bridge code template generator 340, and an enclave generator 345. In FIG. 3, an executable-file/shared-library vulnerability checker 310 is illustrated as being separate from the publisher 320, but the executable-file/shared-library vulnerability checker 310 may be included in the publisher 320.

The encryptor 330 encrypts a payload using an encryption key that is received from the external key management server 315 through the KMS client 325. As shown in FIG. 3, the payload 335 encrypted by the encryptor 330 may be distributed separately from the confidential execution code, unlike the embodiment of FIG. 2.

The payload input to the publisher 320 may be an executable file or a file in the form of a shared library, and the program file distributed by the publisher 320 to the target machines may be configured using a dynamic method in which the encrypted payload and the confidential execution engine code are distributed separately, as shown in FIG. 3. In the dynamic method, in which code related to confidential execution (an enclave.so shared library file) and the payload are generated as individual files and distributed, as shown in FIG. 3, the payload may be protected by encrypting the payload using a received key, and the enclave generator 345 may protect only the confidential execution engine code, having no payload, by applying Protected Code Loader (PCL) technology depending on the selection of an administrator.

Here, the payload 305 used by the publisher and the generated encrypted payload 325 may comprise one or more payloads.

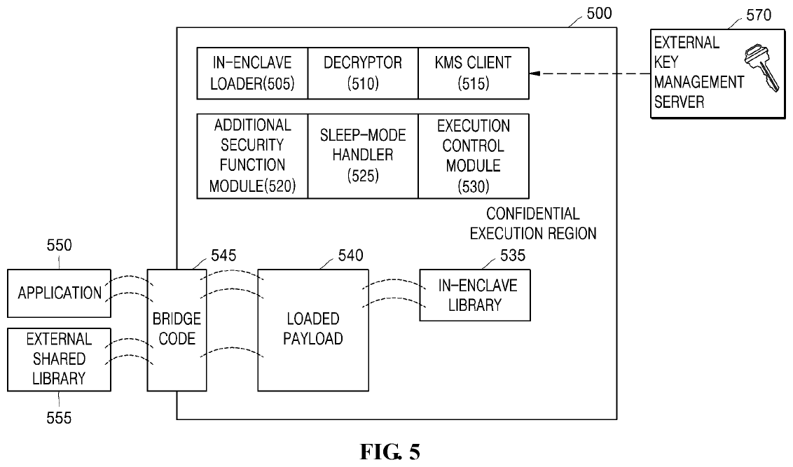

FIG. 5 illustrates an example of an apparatus for executing confidential execution software according to an embodiment of the present invention. The apparatus for executing confidential execution software may be a virtual device implemented in a processor, a confidential execution engine, or the like. The embodiment of FIG. 5 shows an example of the apparatus for executing confidential execution software that is configured in order for an external application 550 to use a payload 540 in the form of a shared library through the linkage thereto.

Referring to FIG. 5, the apparatus 500 for executing confidential execution software according to the present embodiment includes an in-enclave loader 505, a decryptor 510, a KMS client 515, an additional security function module 520, a sleep-mode handler 525, and an execution control module 530, and may execute confidential execution software using an in-enclave library 535, a loaded payload 540, bridge code 545, an application 550, and an external shared library 555. Also, the apparatus 500 for executing confidential execution software may receive a decryption key from an external key management server 570.

The KMS client 515 receives a decryption key from the KMS server and delivers the same to the decryptor 510 in order to decrypt the payload when an enclave is enabled. Depending on the configuration, the KMS client 515 may be implemented as a thread so as to receive the key from the same enclave and to then be terminated, or may be implemented in a manner in which a different enclave is executed so as to receive a key and deliver the key to the CEE, in which the payload is executed, through an inter-enclave communication means.

The decryptor 510 receives a decryption key from the KMS client 515, decrypts the encrypted payload, and stores the decrypted payload in the memory region protected by the enclave. When the KMS client 515 is present in a different enclave, the decryptor 510 receives the key through an inter-enclave communication means.

The execution control module 530 is a module for controlling whether to execute the payload. The execution control module 530 checks whether the current execution environment satisfies a condition for permitting execution of the payload, which is set by the publisher. Only when the check result satisfies the set condition may the execution control module 530 perform the following task. When the condition is not satisfied, the execution control module 530 immediately terminates execution and returns a result, thereby controlling whether to execute the payload. The checking process for execution control may be performed using checking conditions implemented in a module, or may be performed by decrypting and executing an execution control condition checker, which is encrypted and included along with the payload in order to check specified execution conditions. For example, in order to allow the payload to be executed only in a host in which hyperthreading (HT) is disabled, the publisher may implement code in the form of a function configured to check whether HT is enabled in a host and return True or False as the result and an interpreter for mapping the returned True/False to stop/go operations as the execution control condition checker and may include the same, and the execution control module may be configured to execute the execution control condition checker and to then proceed with execution only when the result value of the execution control condition checker indicates that HT is disabled in the corresponding host.

The in-enclave loader 505 changes the decrypted payload to an executable form and loads the same into memory, and connects the invocation of a function that is not present in the payload with the function of a library outside the enclave or the function of an external process through bridge code, or links the same to a function present in the in-enclave library 535 inside the enclave, thereby enabling the payload to be executed normally. When it loads the payload in an executable form into memory, the in-enclave loader 505 may perform Address Space Layout Randomization (ASLR) on the payload by changing the location of the code for each execution unit of the code. When multiple payloads are present, the in-enclave loader 505 repeats the process for the respective payloads, thereby preparing for execution. Then, when preparation for execution is finished, the in-enclave loader 505 deletes the code thereof, thereby leaving no unnecessary code and making the memory available.

The in-enclave library 535 is a set of chunks of code implemented using SGX technology and inserted for execution of the payload in the enclave. The in-enclave library 535 is distributed by taking the form of a shared library and being encrypted along with the payload, or is distributed by being included in the enclave. Here, when the in-enclave library 535 is distributed by being included in the enclave, the in-enclave library is loaded and redeployed along with other chunks of code by a host loader for loading confidential execution code (an enclave.so shared library file). When the in-enclave library 535 is distributed by being encrypted along with the payload, the in-enclave library is handled as if it were the payload, thereby being loaded and redeployed by the in-enclave loader 505. The functions included in the in-enclave library 535 are used as jump targets for substituting for function call targets that are not included in the payload, thereby playing the same role as the shared library of a program running in a native environment. Connection between the payload and the in-enclave library 535 is made by the in-enclave loader 505, and the jump target in the payload includes in-enclave code that is not implemented in the form of a shared library. When function overriding is required in order to perform a different operation in the enclave even though the jump target of a function call is present in the payload, for example, when a function having an identical name and an identical parameter list is present both in the payload and in the in-enclave library 535, the in-enclave loader 505 first establishes linkage to the function present in the in-enclave library 535 or the in-enclave code, thereby enabling function overriding. In this process, when the in-enclave library 535 or the in-enclave code that can be designated as the jump target is not present, bridge code, which is generated by the bridge code template generator and is modified by a user when necessary, is retrieved and connected. When retrieval of suitable bridge code fails, the enclave is terminated and deleted.

The bridge code 545 is a set comprising a wrapper function, which connects the loaded payload with an application outside the confidential execution region or with an external shared library, and function calls using a function pointer. The bridge code 545 connects the confidential execution region with ecalls from the outside thereof and ocalls from the inside thereof in order to enable the desired functions to be called from the opposite region.

The sleep-mode handler 525 stores the state of the enclave and restores the same in order to respond to situations, such as the case where the virtual machine on which the enclave is running is migrated to another node through live migration, the case where the system wakes up after entering a sleep mode, or the case where it is intended to maintain the execution state of the payload without an initialization process even when the node is rebooted. The sleep-mode handler 525 detects the attempt by the virtual machine of the node to enter a sleep mode, issuance of a reboot command, and the like depending on the options set when the confidential execution engine starts execution. Alternatively, in response to an explicit instruction from a user, the sleep-mode handler 525 is invoked, whereby all of the state information including memory information, which is required for restoration of the enclave, is stored in an encrypted file. Here, depending on the reason for entry into the sleep mode, when state information is stored in order to wake up the system after entering the sleep mode, the file containing the state information is encrypted through SGX sealing technology using a key included in a physical CPU, whereby the state information is forced to be restored only in the corresponding host. When the state is stored in order to respond to live migration of the virtual machine, the file containing the state is encrypted using a key received through communication with the KMS server, whereby the corresponding file may be decrypted in the migration target host by receiving the key from the KMS server.

The additional security function module 520 serves as an adapter for performing security functions applied in common to payloads by running in the form of a thread inside the enclave. The additional security function module 520 contains an interface that connects a security function and the like through the process of inserting additional function call code in the publisher when it is necessary to extend the confidential execution environment.

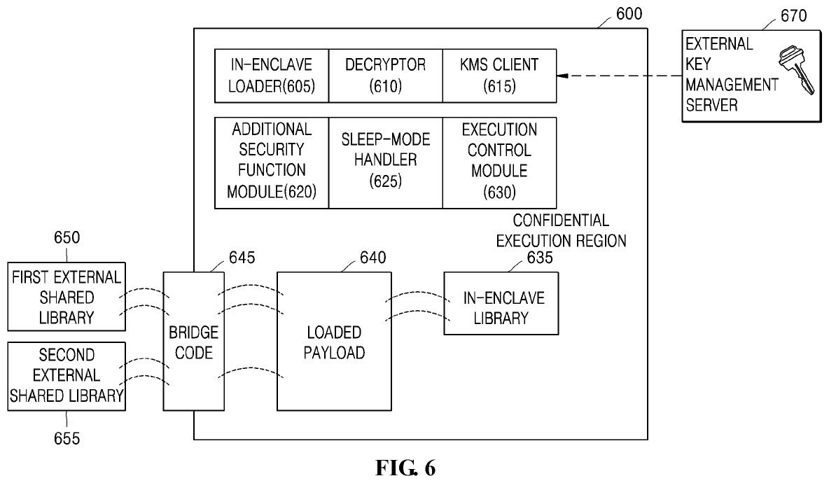

FIG. 6 illustrates an example of an apparatus for executing confidential execution software according to another embodiment of the present invention. The embodiment of FIG. 6 illustrates an example of an apparatus for executing confidential execution software configured in order to use external shared libraries 650 and 660 by connecting the same when a payload 640 is an executable file.

Referring to FIG. 6, the apparatus 600 for executing confidential execution software according to the present embodiment includes an in-enclave loader 605, a decryptor 610, a KMS client 615, an additional security function module 620, a sleep-mode handler 625, and an execution control module 630, and may execute confidential execution software using an in-enclave library 635, a loaded payload 640, bridge code 645, and first and second external shared libraries 650 and 660. Also, the apparatus 600 for executing confidential execution software may receive a decryption key from an external key management server 670.

The KMS client 615 receives a decryption key from the KMS server and delivers the same to the decryptor 610 in order to decrypt the payload when an enclave is enabled. Depending on the configuration, the KMS client 615 may be implemented as a thread so as to receive the key from the same enclave and to then be terminated, or may be implemented in a manner in which a different enclave is executed so as to receive a key and deliver the key to the CEE, in which the payload is executed, through an inter-enclave communication means.

The decryptor 610 receives a decryption key from the KMS client 615, decrypts the encrypted payload, and stores the decrypted payload in the memory region protected by the enclave. When the KMS client 615 is present in a different enclave, the decryptor 610 receives the key through an inter-enclave communication means.

The execution control module 630 is a module for controlling whether to execute the payload. The execution control module 630 checks whether the current execution environment satisfies a condition for permitting execution of the payload, which is set by the publisher. Only when the check result satisfies the set condition may the execution control module 630 perform the following task. When the condition is not satisfied, the execution control module 630 immediately terminates execution and returns a result, thereby controlling whether to execute the payload. The checking process for execution control may be performed using checking conditions implemented in a module, or may be performed by decrypting and executing an execution control condition checker, which is encrypted and included along with the payload in order to check specified execution conditions. For example, in order to allow the payload to be executed only in a host in which hyperthreading (HT) is disabled, the publisher may implement code in the form of a function configured to check whether HT is enabled in a host and return True or False as the result and an interpreter for mapping the returned True/False to stop/go operations as the execution control condition checker and may include the same, and the execution control module may be configured to execute the execution control condition checker and then proceed with execution only when the result value of the execution control condition checker indicates that HT is disabled in the corresponding host.

The in-enclave loader 605 changes the decrypted payload to an executable form and loads the same into memory, and connects the invocation of a function that is not present in the payload with the function of a library outside the enclave or the function of an external process through bridge code or links the same to a function present in the in-enclave library 635 inside the enclave, thereby enabling the payload to be executed normally. When it loads the payload in an executable form into memory, the in-enclave loader 605 may perform Address Space Layout Randomization (ASLR) on the payload by changing the location of the code for each execution unit of the code. When multiple payloads are present, the in-enclave loader 605 repeats the process for the respective payloads, thereby preparing for execution. Then, when preparation for execution is finished, the in-enclave loader 605 deletes the code thereof, thereby leaving no unnecessary code and making the memory available.

The in-enclave library 635 is a set of chunks of code implemented using SGX technology and inserted in order to execute the payload in the enclave. The in-enclave library 635 is distributed by taking the form of a shared library and being encrypted along with the payload, or is distributed by being included in the enclave. Here, when the in-enclave library 635 is distributed by being included in the enclave, the in-enclave library is loaded and redeployed along with other chunks of code by a host loader for loading confidential execution code (an enclave.so shared library file). When the in-enclave library 635 is distributed by being encrypted along with the payload, the in-enclave library is handled as if it were the payload, thereby being loaded and redeployed by the in-enclave loader 605. The functions included in the in-enclave library 635 are used as jump targets for substituting for function call targets that are not included in the payload, thereby playing the same role as the shared library of a program running in a native environment. Connection between the payload and the in-enclave library 635 is made by the in-enclave loader 605, and the jump target in the payload includes in-enclave code that is not implemented in the form of a shared library. When function overriding is required in order to perform a different operation in the enclave even though the jump target of a function call is present in the payload, for example, when a function having an identical name and an identical parameter list is present both in the payload and in the in-enclave library 635, the in-enclave loader 605 first establishes linkage to the function present in the in-enclave library 635 or in the in-enclave code, thereby enabling function overriding. In this process, when code that can be designated as the jump target is not present in the in-enclave library 635 or in the code present in the confidential execution region, bridge code, which is generated by the bridge code template generator and is modified by a user when necessary, is retrieved and connected. When retrieval of suitable bridge code fails, the enclave is terminated and deleted.

The bridge code 645 is a set comprising a wrapper function, which connects the loaded payload with an application outside the confidential execution region or with an external shared library, and function calls using a function pointer. The bridge code 645 connects the confidential execution region with ecalls from the outside thereof and ocalls from the inside thereof in order to enable the desired functions to be called from the opposite region.

The sleep-mode handler 625 stores the state of the enclave and restores the same in order to respond to situations, such as the case where the virtual machine on which the enclave is running is migrated to another node through live migration, the case where the system wakes up after entering a sleep mode, or the case where it is intended to maintain the execution state of the payload without an initialization process even when the node is rebooted. The sleep-mode handler 625 detects the attempt by the virtual machine in the node to enter a sleep mode, issuance of a reboot command, and the like depending on the options set when the confidential execution engine starts execution. Alternatively, in response to an explicit instruction from a user, the sleep-mode handler 625 is invoked, whereby all of the state information, including memory information, which is required for restoration of the enclave, is stored in an encrypted file. Here, depending on the reason for entry into the sleep mode, when state information is stored in order to wake up the system after entering the sleep mode, the file containing the state information is encrypted through SGX sealing technology using a key included in a physical CPU, whereby the state information is forced to be restored only in the corresponding host. When the state is stored in order to respond to live migration of the virtual machine, the file containing the state is encrypted using a key received through communication with the KMS server, whereby the corresponding file may be decrypted in the migration target host by receiving the key from the KMS server.

The additional security function module 620 serves as an adapter for performing security functions applied in common to payloads by running in the form of a thread inside the enclave. The additional security function module 620 contains an interface that connects a security function and the like through the process of inserting additional function call code in the publisher when it is necessary to extend a confidential execution environment.

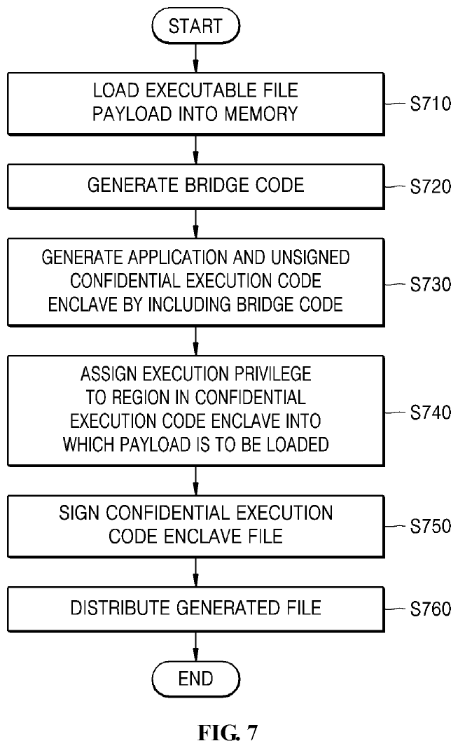

FIG. 7 is a flowchart illustrating an example of a method for distributing confidential execution software according to an embodiment of the present invention. The method for distributing confidential execution software according to the present embodiment may be performed when a payload is an executable file.

Referring to FIG. 7, in the method for distributing confidential execution software according to an embodiment of the present invention, an executable file payload is loaded into memory at step S710.

Here, at step S710, when one or more payloads are present, each of the payloads may be loaded into memory.

Also, in the method for distributing confidential execution software according to an embodiment of the present invention, bridge code is generated at step S720.

Here, in order to determine whether bridge code is required for execution of the payload, the executable file is put into a bridge code template generator, whereby bridge code may be generated. The bridge code template generator receives the executable file and generates an ocall for calling an external library function, which is used in the payload but is not included in the payload, thereby enabling the payload to call the corresponding function.

Also, in the method for distributing confidential execution software according to an embodiment of the present invention, an application and an unsigned confidential execution code enclave are generated by including the bridge code at step S730.

Here, the added code is compiled along with CEE component files, whereby the unsigned confidential execution engine code (an enclave.so shared library file) may be generated.

Also, in the method for distributing confidential execution software according to an embodiment of the present invention, execution privileges are assigned to the region in the confidential execution code enclave, into which the payload is to be loaded, at step S740.

Also, in the method for distributing confidential execution software according to an embodiment of the present invention, the confidential execution code enclave file is signed at step S750.

Also, in the method for distributing confidential execution software according to an embodiment of the present invention, the generated file is distributed at step S760.

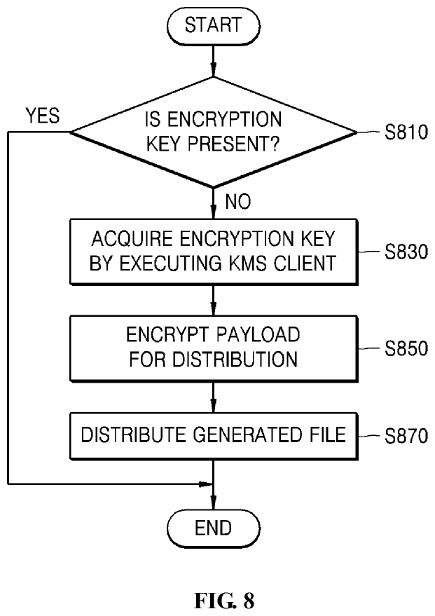

FIG. 8 is a flowchart illustrating a part of the process of a method for distributing confidential execution software according to an embodiment of the present invention.

Referring to FIG. 8, in the method for distributing confidential execution software according to an embodiment of the present invention, whether an encryption key is present is determined at step S810.

Also, in the method for distributing confidential execution software according to an embodiment of the present invention, an encryption key is acquired by executing a KMS client at step S830.

Here, the encryption key may be received from a KMS server.

Also, in the method for distributing confidential execution software according to an embodiment of the resent invention, the payload to be distributed is encrypted at step S850.

Here, the payload may be encrypted using the encryption key received at step S830.

Here, not only the payload but also an additional library may be encrypted when necessary.

Also, in the method for distributing confidential execution software according to an embodiment of the present invention, the generated file is distributed at step S870.

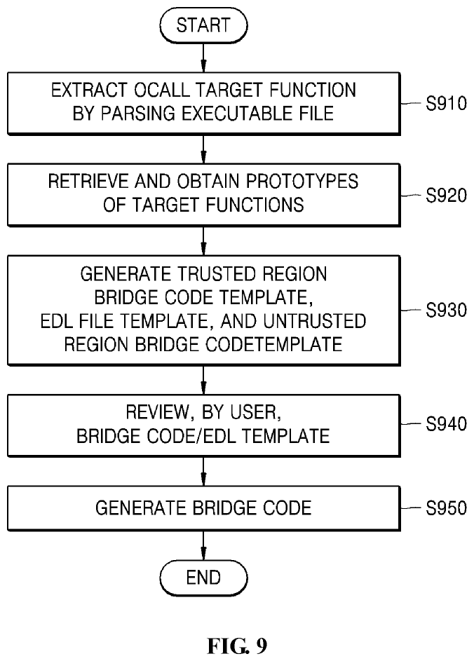

FIG. 9 is a flowchart illustrating another part of the process of a method for distributing confidential execution software according to an embodiment of the present invention.

Referring to FIG. 9, in the method for distributing confidential execution software according to an embodiment of the present invention, an executable file is parsed, whereby an ocall target function is extracted at step S910.

Here, the executable file is parsed, whereby a list of functions called from the corresponding code is generated. Then, each of the functions to be called is classified depending on whether the function is present in the payload or uses an external library through connection therewith, and the functions already included in the payload or the functions that can be handled in the in-enclave library are removed from the list.

Also, in the method for distributing confidential execution software according to an embodiment of the present invention, the protypes of the target functions are obtained by retrieving the same at step S920.

Here, based on the name of an external library, to which the functions that cannot be internally handled belong, and on the names of the functions, the prototypes of the corresponding functions are retrieved from header files present in a given search target file system directory, whereby the prototypes of the corresponding functions are obtained.

Also, in the method for distributing confidential execution software according to an embodiment of the present invention, a trusted region bridge code template, an EDL file template, and an untrusted region bridge code template are generated at step S930.

Here, a function name and a parameter list are extracted from the found prototype, an ocall is generated based thereon, functions are generated respectively in the untrusted region and the trusted region, and the prototype of the ocall is added in the EDL file.

More specifically describing the process of adding the prototype of the ocall in the EDL file, the function prototype of the ocall is generated based on the extracted parameter list, and the function to be included in the untrusted region, an EDL file entry, and the function to be included in the trusted region are generated. Each of them are described as follows.

1) An example of the generated EDL file entry includes a function name to which a prefix is added, a parameter list in which a parameter for a return value is added, and an attribute value for each parameter. When the return type of the target function is void, the parameter for the return value may be omitted, whereas when the function has a return value, a parameter having a void pointer (“void *”) type for the return value is set as the first parameter of the ocall, whereby the return value may be returned through the pointer. Then, the extracted parameter list is used without change as the parameters from the second parameter of the ocall in order to deliver the parameters to the target function. Finally, for each of the parameters of the ocall, the attribute value that SGX requires to write in the parameter list of the function prototype to be added in the EDL file is additionally set. Here, each of the EDL entries, including the attribute, may be manually modified by a user when necessary, but otherwise, the entries may be automatically set.

2) The untrusted region function of the generated ocall calls the function that is intended to be invoked from the payload without change. When necessary, code for checking whether parameters corresponding to memory address values point to the enclave region is added.

3) The trusted region function of the generated ocall becomes the call target that is actually invoked when the original function call in the payload is executed, and may be invoked by calling the ocall added in the EDL file using the same parameters as the parameters of the original function. When necessary, code for checking whether parameters corresponding to memory address values point to the enclave region is added in the corresponding function.

When there is a function that is not retrieved, a function prototype template having the name of the function and an empty parameter list is generated in order to enable a user to modify the name of the corresponding function, the parameter list thereof, and the like, and the generated function prototype template is written in the EDL file and is commented out. In this case, nothing is generated in the trusted region or the untrusted region. Also, when a user manually adds a function, relevant functions are generated in the same locations, and the function prototype thereof is added in the EDL file.

Although an available connection target is present, when a user intends to connect to another function, connection to the function is generated in the same manner as the above-described manner, and the in-enclave loader may be notified of the fact that the connection has precedence by changing the type of the prefix added to the function.

Also, in the method for distributing confidential execution software according to an embodiment of the present invention, a result of reviewing bridge code and the EDL template is received from the user at step S940.

The user reviews the generated bridge code template and modifies the same when necessary, thereby generating the final bridge code. When the user does not modify the generated bridge code template, the template becomes the final bridge code.

Also, in the method for distributing confidential execution software according to an embodiment of the present invention, bridge code is generated at step S950.

Here, with regard to a memory region accessible through a parameter, the code in the generated template sets a parameter attribute such that the memory region is copied by default when movement between the trusted and untrusted regions (the inside and outside of the enclave) is caused by an ocall and an ecall based on the boundary between the inside and outside of the enclave, but if necessary, not the execution code but data in external memory may be directly referenced from the inside of the enclave at the discretion of the user who runs the publisher by modifying the attribute or by applying a change, such as insertion, modification, deletion, and the like, to the relevant bridge code. When the attribute is set such that external memory is directly referenced, code for performing a necessary security check may be added depending on the determination of the user.

Here, if necessary, an ecall may be generated even for the executable file payload depending on the intention of the user, whereby the function included in the executable file payload is enabled to be called from the outside.

After the bridge code is generated, the publisher generates a constructor function and a destructor function in the untrusted region and adds the same in the confidential execution engine code (the enclave.so shared library file). Here, the constructor function invokes an ecall for performing an initialization task in order to perform preparation tasks, such as initializing the enclave, loading and connecting a payload, and the like, before a main function is executed in the untrusted region code, which will use the confidential execution engine code (the enclave.so shared library file) by linking the same, and the destructor function removes the enclave.

The following operation of the publisher is the same as the process performed after the generation of bridge code when the payload is an executable file.

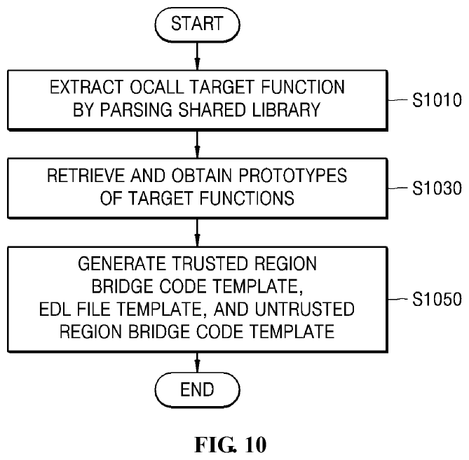

FIG. 10 is a flowchart illustrating part of the process of a method for distributing confidential execution software according to another embodiment of the present invention. The process in FIG. 10 shows part of the process of the method for distributing confidential execution software when a payload is a shared library.

Referring to FIG. 10, in the method for distributing confidential execution software according to an embodiment of the present invention, a shared library is parsed, whereby an ocall target function is extracted at step S1010.

Also, in the method for distributing confidential execution software according to an embodiment of the present invention, the prototype of the target function is retrieved and acquired at step S1030.

Also, in the method for distributing confidential execution software according to an embodiment of the present invention, a trusted region bridge code template, an EDL file template, and an untrusted region bridge code template are generated at step S1050.

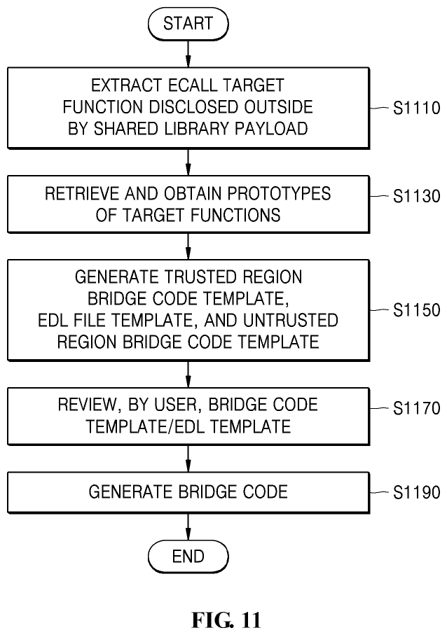

FIG. 11 is a flowchart illustrating another part of the process of a method for distributing confidential execution software according to another embodiment of the present invention. FIG. 11 illustrates a part of the process of the method for distributing confidential execution software when a payload is a shared library, like the process in FIG. 10. The process of FIG. 11 may be performed so as to follow the process of FIG. 10, but a part of the process in FIG. 11 may be performed before the process of FIG. 10.

Referring to FIG. 11, in the method for distributing confidential execution software according to the present embodiment, an ecall target function that a shared library payload discloses to the outside is extracted at step S1110.

Also, in the method for distributing confidential execution software according to the present embodiment, the prototypes of the target functions are retrieved and obtained at step S1130.

Also, in the method for distributing confidential execution software according to the present embodiment, a trusted region bridge code template, an EDL file template, and an untrusted region bridge code template are generated at step S1150.

Also, in the method for distributing confidential execution software according to the present embodiment, a user's review of the bridge code template and the EDL template is received at step S1170.

Also, in the method for distributing confidential execution software according to the present embodiment, bridge code is generated at step S1190.

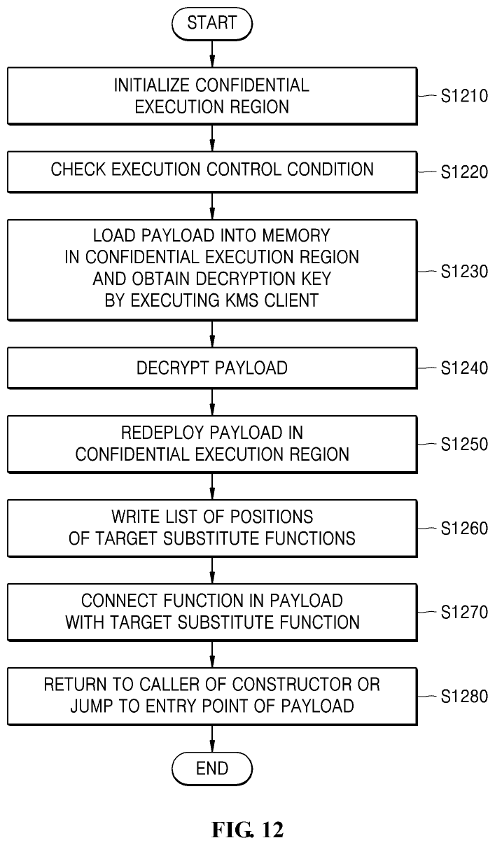

FIG. 12 is a flowchart illustrating an example of a method for executing confidential execution software according to an embodiment of the present invention.

Referring to FIG. 12, in the method for executing confidential execution software according to an embodiment of the present invention, a confidential execution region is initialized at step S1210.

Here, after a user authentication and enclave attestation task is performed normally as a preparation phase for generating and using an enclave, when an executable app linked to an enclave generation shared library (enclave.so) is executed, a constructor implemented in a different shared library or the enclave generation shared library is invoked, whereby the enclave is initialized and a payload may be prepared.

Also, in the method for executing confidential execution software according to an embodiment of the present invention, an execution control condition is checked at step S1220.

Here, an execution control module executes an execution control condition checker, which is received along with the payload and decrypted by a decryptor, thereby checking whether the current execution environment satisfies the execution environment conditions specified by a publisher. The execution control module proceeds with the following task only when the execution environment condition is satisfied. When the condition is not satisfied, the execution control module immediately terminates execution and returns a result so as to execute a destructor. When the execution control condition checker is included in the enclave, the constructor is made to execute the execution control condition checker before execution of a KMS client and a decryptor, whereby unnecessary operations may be prevented.

Also, in the method for executing confidential execution software according to an embodiment of the present invention, the payload is loaded into memory in the confidential execution region, and the KMS client is executed, whereby a decryption key is acquired at step S1230.

Also, in the method for executing confidential execution software according to an embodiment of the present invention, the payload is decrypted at step S1240.

Also, in the method for executing confidential execution software according to an embodiment of the present invention, the payload is redeployed inside the confidential execution region at step S1250.

Here, for the redeployment, the in-enclave loader may arrange the code possessed thereby in the memory according to a redeployment sequence, which is set to be the same as the process performed by a general loader, depending on the file format of the payload.

Also, in the method for executing confidential execution software according to an embodiment of the present invention, a list comprising the positions of target substitute functions is written at step S1260.

Here, the process of acquiring the position of the corresponding substitute function code may be performed as follows. For an external library function that is not included in the payload, a function in the payload that needs to be replaced in order to execute the function in the enclave, and the like, the name of the function that generally needs to be handled or the name of the function expected to be used in the bridge code and an in-enclave library is set as a key. Then, the function to be actually invoked in response to this function is retrieved by searching the bridge code or the in-enclave library for a function having the corresponding name and the necessary parameter list specified in a predefined rule, and the memory location at which the retrieved function is located in the enclave is set as a value. Then, an entry is generated by pairing the key and the value, and the entry (key, value) is managed and acquired using a data structure such as a table or the like. When two or more functions having different types of prefixes are present in the publisher as functions to be connected to the same function, the function to be connected may be selected according to a previously set priority order, and may be updated in the data structure.

Also, in the method for executing confidential execution software according to an embodiment of the present invention, the function in the payload is connected with the target substitute function at step S1270.

Here, the obtained substitute function code may be registered in such a way that the memory address of the function to be actually called is acquired by searching the above-described data structure for the name of the target function to be replaced in the payload, and connection is made by setting the acquired memory address in the data structure that is referenced when the original function is called. For example, the location of the function intended to be invoked from the payload, which is recorded in the code or the data structure, such as a table or the like, that is used for the external function invocation from the payload (i.e., a Procedure Linkage Table (PLT) and a Global Offset Table (GOT) in the Linux/ELF format), may be replaced with the memory address at which the code in the enclave (bridge code or in-enclave library) is located, and the new memory address may be used. Also, in order to respond to the case where an external function calls a function in the enclave or to respond to the requirements of a new jump target, switched to depending on a given condition, a function pointer variable is allocated to the trusted region function of the bridge code, and code is generated in the publisher such that the function to which the corresponding function pointer variable points is invoked and executed by calling the function pointer. The in-enclave loader retrieves and allocates the memory address of the function to be actually called, that is, the memory address to be put in the function pointer variable used in each corresponding function, in the same manner as the above-described method, whereby the obtained substitute function code may be registered.

Also, in the method for executing confidential execution software according to an embodiment of the present invention, the process returns to the caller of the constructor or jumps to the entry point of the payload at step S1280.

Here, when the redeployment and redirection by the in-enclave loader are completed, the operation of the in-enclave loader may be terminated by performing the following operation depending on the type of the payload.

Here, when the payload is an executable file, arguments for the payload, which are received through a constructor when the CEE environment is executed, are set to be pushed in a specified stack region, and the payload may be executed by jumping to the entry point of an executable app or the main( ) function.

Here, when the payload is a shared library, execution of the in-enclave loader is finished, and the execution result value is returned to the constructor. The constructor executes the remaining code and returns, whereby the process is finished.

Here, depending on the manner in which execution of the payload is terminated, it may be determined whether to execute the main function code in the untrusted code region when the payload is an executable file or whether to execute the external process code subsequent to invocation of the payload when the payload is a shared library. That is, when execution of the payload is terminated by returning to the main function, the main function code is executed, and a destructor may also be executed. However, when execution of the payload is terminated by calling the exit( ) function or the like, neither the main function code nor the destructor may be executed.

Here, when execution is completely terminated, the executable file payload terminates the enclave by calling a destructor, which is implemented by the publisher along with a constructor in a different shared library or in an enclave generation shared library (enclave.so), whereby the process of the application (App.) may be terminated.

Here, when the payload is a shared library, execution is terminated, and the process is returned to the constructor, whereby the process that generates and uses the corresponding enclave is enabled to use the enclave while executing the original operation thereof. The enclave may be terminated in such a way that a destructor is called when the corresponding process is terminated.

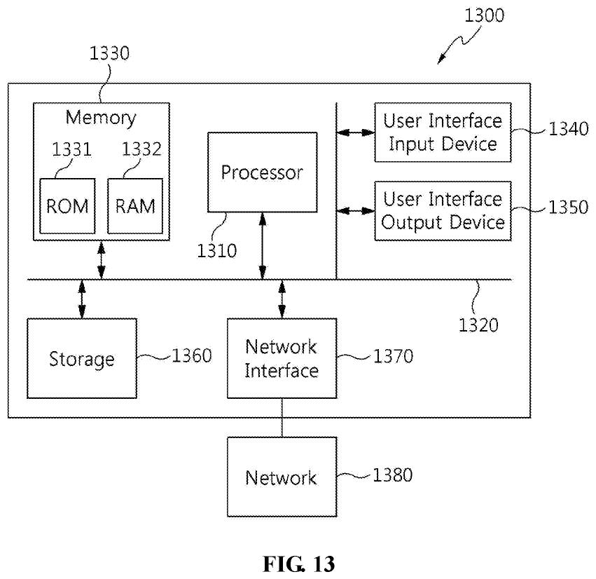

FIG. 13 is a block diagram illustrating a computer system according to an embodiment of the present invention.

Referring to FIG. 13, the apparatus for distributing confidential execution software according to an embodiment of the present invention may be implemented in a computer system 1300 including a computer-readable recording medium. As illustrated in FIG. 13, the computer system 1300 may include one or more processors 1310, memory 1330, a user-interface input device 1340, a user-interface output device 1350, and storage 1360, which may communicate with each other via a bus 1320. Also, the computer system 1300 may further include a network interface 1370 connected with a network 1380. The processor 1310 may be a central processing unit or a semiconductor device for executing processing instructions stored in the memory 1330 or the storage 1360. The memory 1330 and the storage 1360 may be any of various types of volatile or nonvolatile storage media. For example, the memory may include ROM 1331 or RAM 1332.

The apparatus 1300 for distributing confidential execution software according to an embodiment of the present invention includes one or more processors 1310 and executable memory 1330 for storing at least one program executed by the one or more processors 1310. The at least one program may load a payload into memory, check vulnerabilities related to the payload, generate bridge code for calling a function that is not present in the payload, among functions used in the payload, generate confidential execution code for generating a confidential execution region in a target cloud node having privileges to execute the payload, encrypt the payload, and distribute the confidential execution code and the encrypted payload.

Here, for one or more payloads, the at least one program may load each of the payloads into the memory.

Here, the payload used by a publisher and the generated encrypted payload may comprise one or more payloads.

Here, a list comprising a function required for invocation from the outside of the confidential execution code, among the code in the payload, and a function to be invoked when an external process invokes the code included in the payload is extracted, and the bridge code may be generated based on the list.

Here, the confidential execution code may include at least one component that is required for implementation of a confidential execution engine (CEE).

Here, the component may include at least one of an in-enclave loader, a decryptor, a Key Management System (KMS) client, an additional security function module, a sleep-mode handler, an execution control module, and an in-enclave library.

Here, an encryption key is received from an external server, and the payload may be encrypted using the encryption key.

Here, the encryption key may be generated by the external server based on at least one of identification information of the corresponding confidential execution engine (CEE) and the version information of the payload.

Here, whether a security measure is applied to the payload may be additionally checked through static binary analysis on the payload.

Here, when a vulnerability related to the payload is found during checking, the running task may be immediately stopped.

Here, the payload may be an executable file or a shared library.

According to the present invention, an application or shared library that is the target of confidential execution may be executed using only functions provided by a CPU without modifying a target binary in a virtual machine of a cloud node, in a container instance, or on a compromised OS running in a bare-metal environment, whereby executable code in a file system may be prevented from being exposed. Also, a portion of memory into which code and data are loaded during execution is made executable in an encrypted state, whereby high confidentiality may be provided for the executable code and data.

Also, because the present invention is able to provide a single-program confidential execution platform capable of applying an additional security function to other code to be executed, if a CPU and a mainboard that are used support Intel's SGX functions while an environment (e.g., a hypervisor or OS) in which software is run supports the use of the functions of the CPU, the code may be executed not only in a bare metal environment but also in virtual machine and container environments.

As described above, the method and apparatus for distributing confidential execution software according to the present invention are not limitedly applied to the configurations and operations of the above-described embodiments, but all or some of the embodiments may be selectively combined and configured, so the embodiments may be modified in various ways.

What is claimed is:

1. A method for distributing confidential execution software, comprising:
loading a payload into memory;
checking a vulnerability related to the payload;
generating bridge code for calling a function that is not present in the payload, among functions used in the payload;
generating confidential execution code for generating a confidential execution region in a target cloud node having privileges to execute the payload;
encrypting the payload; and
distributing the confidential execution code and the encrypted payload.

2. The method of claim 1, wherein generating the bridge code is configured to extract a list comprising a function for invoking code outside the confidential execution code, among code in the payload, and a function that is called when an external process invokes code included in the payload, and is configured to generate the bridge code based on the list.

3. The method of claim 1, wherein the confidential execution code includes at least one component that is necessary in order to implement a Confidential Execution Engine (CEE).

4. The method of claim 3, wherein the component includes at least one of an in-enclave loader, a decryptor, a Key Management System (KMS) client, an additional security function module, a sleep-mode handler, an execution control module, and an in-enclave library.

5. The method of claim 1, wherein encrypting the payload is configured to receive an encryption key from an external server and to encrypt the payload based thereon.

6. The method of claim 5, wherein the encryption key is generated by the external server based on at least one of identification information of a corresponding Confidential Execution Engine (CEE) and version information of the payload.

7. The method of claim 1, wherein checking the vulnerability is configured to additionally check whether a security measure is applied to the payload through static binary analysis on the payload.

8. The method of claim 1, wherein checking the vulnerability is configured to immediately stop a running process when the vulnerability related to the payload is found.

9. The method of claim 1, wherein the payload is an executable file or a shared library.

10. A method for executing confidential execution software, comprising:
initializing a confidential execution region;
checking a condition for confidential execution;
loading an encrypted payload into memory in the confidential execution region;
receiving a decryption key from an external server;
decrypting the payload using the decryption key;
redeploying the decrypted payload in the confidential execution region;
writing a list of positions of target substitute functions and connecting a function in the payload with the target substitute function; and
executing code in the payload.

11. The method of claim 10, wherein the confidential execution region includes at least one of an in-enclave loader, a decryptor, a Key Management System (KMS) client, an additional security function module, a sleep-mode handler, an execution control module, and an in-enclave library.

12. The method of claim 10, wherein checking the condition for the confidential execution is configured to check whether an environment in which the confidential execution software is executed satisfies a preset execution environment condition and to immediately terminate execution of the confidential execution software when the preset execution environment condition is not satisfied.

13. An apparatus for distributing confidential execution software, comprising:
a payload-loading unit for loading a payload for generating confidential execution code into memory;
a vulnerability-checking unit for checking a vulnerability related to the payload;
an encryption key reception unit for receiving an encryption key from an external server;
an encryption unit for encrypting the payload using the encryption key;
a confidential execution code generation unit for generating confidential execution code for the payload; and
a distribution unit for distributing the encrypted payload and the confidential execution code.

14. The apparatus of claim 13, wherein the confidential execution code includes at least one component that is necessary in order to implement a Confidential Execution Engine (CEE).

15. The apparatus of claim 14, wherein the component includes at least one of an in-enclave loader, a decryptor, a Key Management System (KMS) client, an additional security function module, a sleep-mode handler, an execution control module, and an in-enclave library.

16. The apparatus of claim 13, wherein the encryption key is generated by the external server based on at least one of identification information of a corresponding Confidential Execution Engine (CEE) and version information of the payload.

17. The apparatus of claim 13, wherein the vulnerability-checking unit additionally checks whether a security measure is applied to the payload through static binary analysis on the payload.

18. The apparatus of claim 13, wherein the vulnerability-checking unit immediately stops a running process when the vulnerability related to the payload is found.

19. The apparatus of claim 13, wherein the payload is an executable file or a shared library.
